(19) United States
(12) Patent Application Publication
(10) Pub. No.: US 2004/0092423 A1
(43) Pub. Date: May 13, 2004

(54) Composition for reducing fabric wrinkles and method for using the same

(76) Inventors: John F. Billman, Scottsdale, AZ (US); Rosanne Benavides, Phoenix, AZ (US)

Correspondence Address: Wendy S. Neal, Snell & Wilmer L.L.P., One Arizona Center, 400 East Van Buren, Phoenix, AZ, 85004-2202, US

(21) Appl. No.: 10/294,918

(22) Filed: Nov. 12, 2002

(51) Int. Cl. C11D 1/00

(52) U.S. Cl. 510/466

(57) ABSTRACT

A composition for reducing fabric wrinkles is provided that generally comprises a silicone compound, a wetting agent, a drying agent, a liquid carrier, and a fragrance. The composition is preferably water clear, provides wrinkle reduction in a variety of fabrics, and is rapidly evaporated from the fabric. In accordance with one aspect of an exemplary embodiment of the invention, the wrinkle reducing composition does not employ a fragrance solubilizing agent.

### FIELD OF INVENTION

The present invention relates to compositions for treating fabric articles, and more particularly, compositions for reducing wrinkles in fabric articles and methods of using the same.

### BACKGROUND OF THE INVENTION

Wrinkling of fabric articles occurs when the fibers in the fabric are uniformly bent or distorted along a “fold” or “wrinkle” line across the weave of the fabric. Wrinkles may vary in intensity—both in length and depth—and they can distort the creases and seams of fabric garments and generally affect the so-called “neatness” of a garment. Wrinkles can be relaxed or removed in a number of ways, such as, for example, by the use of heat, chemical relaxation (hydration), solvation, lubrication, and/or by mechanical agitation, such as, for example, by stretching.

A variety of wrinkle reducing fabric sprays have been introduced to the market in recent years. Currently-marketed wrinkle reducing formulations, however, are generally slow-drying, tend to stiffen fabrics, and some are not colorless or clear. Moreover, many prior art wrinkle reducing sprays exhibit varied particle sizes when dispensed, which potentially lessens the efficacy of the treatment composition.

What is needed in the art is a composition for reducing wrinkles in fabric articles that effectively addresses these and other disadvantages of prior art wrinkle reducing compositions.

### SUMMARY OF THE INVENTION

This summary of the invention is intended to introduce the reader to various exemplary aspects of the invention. Particular aspects of the invention are pointed out in other sections hereinbelow, and the invention is set forth in the appended claims which alone demarcate its scope.

In accordance with an exemplary embodiment of the invention, a composition for reducing fabric wrinkles is provided that generally comprises a silicone compound, a wetting agent, a drying agent, a liquid carrier, and a fragrance. The composition is preferably water clear, provides wrinkle reduction in a variety of fabrics, and is rapidly evaporated from the fabric. In accordance with one aspect of an exemplary embodiment of the invention, the wrinkle reducing composition does not employ a fragrance solubilizing agent.

In accordance with another exemplary embodiment of the present invention, a composition for reducing fabric wrinkles is provided. The composition generally includes: (i) from about 0.25% to about 16% by weight of a silicone compound, such as, for example, a silicone quaternary compound; (ii) from about 0.05% to about 3.5% by weight of a wetting agent, such as, for example, a potassium salt of a silicone copolyol; (iii) from about 1% to about 15% by weight of a drying agent, such as, for example, an alcohol; (iv) at least about 65% by weight of a liquid carrier, such as, for example, water; (v) from about 0.01% to about 1% by weight of a fragrance. In accordance with another exemplary embodiment, the composition includes one or more optional additives, such as, for example, a preservative, an antifoaming agent, a bacteriocide, a fungicide, an antistatic agent, a miticide, an insect repellant, a UV absorber/sunscreen, a fabric color rejuvenator, and/or a colorant.

In accordance with an exemplary aspect of the present invention, the wrinkle reducing composition exhibits good wetting properties, such that the composition effectively penetrates fibers both hydrophilic and hydrophobic fibers of fabric articles to effectively combat wrinkles within the fibers.

In accordance with another aspect of an exemplary embodiment of the invention, the composition dries quickly after being applied to a fabric article, such that the fabric article is ready to use and/or to wear soon after treatment with the composition.

In accordance with another aspect of an exemplary embodiment of the present invention, the wrinkle reducing composition is not damaging to fabric articles under conditions of normal use and does not leave a visible residue on fabric articles treated therewith.

In accordance with yet another aspect of the invention, the composition is safe and effective for treatment of a variety of types of fabric articles, including both natural and synthetic fabrics.

In accordance with still another aspect of the invention, the wrinkle reducing composition may be used as an ironing aid, particularly for dark-colored fabric articles.

### DETAILED DESCRIPTION

The following descriptions are of exemplary embodiments of the invention only, and are not intended to limit the scope, applicability or configuration of the invention in any way. Rather, the following description is intended to provide convenient illustrations for implementing various embodiments of the invention. As will become apparent, various changes may be made in the function and arrangement of the elements described in these embodiments without departing from the sprit and scope of the invention.

Silicone Compound

In accordance with one embodiment of the invention, a wrinkle reducing composition includes a silicone compound. In accordance with one aspect of an exemplary embodiment of the invention, the silicone compound comprises a quaternary silicone compound, such as, for example, a silicone C-18 quaternary compound. Preferably, the silicone compound is a water-soluble silicone compound. One exemplary compound suitable for use in accordance with various embodiments of the invention is that sold under the trade name Lambent CSI-Q, available from Lambent Technologies, Inc. of Norcross, Ga.

In accordance with one aspect of an exemplary embodiment of the invention, the silicone compound is present in the composition at of level of from about 0.25% to about 16% by weight of the wrinkle reducing composition. Preferably, the silicone compound comprises from about 0.5% to about 10% by weight of the composition, and more preferably, from about 0.5% to about 5% by weight of the composition.

Other compounds that impart a soft hand to the fabric article after application and drying may be used in addition to or as a substitute for the silicone compound in accordance with other exemplary embodiments of the invention. Preferably, such compounds would not impart a greasy feel to fabric articles, including fabric articles made from synthetic fabrics. For example, aliphatic quaternary amines, aliphatic ester quaternary amines, and other fabric softening agents may be useful in accordance with this aspect of the invention. Preferably, the compounds utilized would not significantly detrimentally affect the clarity, stability, homogeneity, or other desirable physical characteristics of the wrinkle reducing composition. For example, compounds utilized in accordance with this aspect of an exemplary embodiment are preferably clear or near-colorless and do not impart an undesirable odor to the wrinkle reducing composition.

Wetting Agent

In accordance with another aspect of an exemplary embodiment of the invention, the wrinkle reducing composition includes a wetting agent. Preferably, the wetting agent is water soluble or water dispersible, and exhibits favorable wetting and spreading characteristics when applied to fabrics. Preferably, the wetting agent, in the amount employed, does not significantly detrimentally affect the clarity, stability, homogeneity, odor, or other desirable physical characteristics of the wrinkle reducing composition.

In accordance with one aspect of an exemplary embodiment of the invention, the wetting agent comprises, for example, a potassium salt of a silicone copolyol. One such exemplary wetting agent suitable for use in accordance with various embodiments of the invention is that sold under the trade name Lambent SW-CP-K, available from Lambent Technologies, Inc. of Norcross, Ga.

In accordance with one aspect of an exemplary embodiment of the invention, the wetting agent is present in the composition at of level of about one part wetting agent to about five parts of the silicone compound. The wetting agent preferably comprises from about 0.05% to about 3.5% by weight of the wrinkle reducing composition. Preferably, the wetting agent comprises from about 0.1% to about 2% by weight of the composition, and more preferably, from about 0.2% to about 1% by weight of the composition.

Liquid Carrier

In accordance with another aspect of an exemplary embodiment, the liquid carrier comprises at least about 65% by weight of the wrinkle reducing composition. Preferably, the liquid carrier comprises from about 75% to about 95% by weight of the composition, and more preferably, from about 88% to about 93% by weight of the composition. However, if effective solubilization and/or dispersion of the other components of the composition can be obtained, less may be used. The preferred liquid carrier for use in accordance with an exemplary embodiment of the present invention is water, which can be distilled, deionized, or unrefined tap water.

Drying Agent

In accordance with another aspect of an exemplary embodiment of the invention, the wrinkle reducing composition includes a drying agent. The drying agent may comprise any compound that enhances the evaporability of the wrinkle reducing composition from a fabric article after treatment of the fabric article, so as to reduce the amount of time necessary for drying until the fabric article is suitable for use or wear. The drying agent preferably comprises a low molecular weight monohydric alcohol, such as, for example, ethanol, methanol, or isopropanol; a polyol, such as ethylene glycol, diethylene glycol, propylene glycol, or dipropylene glycol; a polyol derivative; or a glycol ether. Such a fraction of a monohydric alcohol, polyol, polyol derivative, or glycol ether may serve to enhance the solubility of various components and to aid in the maintenance of a clear, stable, microemulsion of the various components. SDA-40B alcohol, which is an ethanol product, is used as a drying agent in accordance with one embodiment of the invention.

In an exemplary embodiment of the present invention, the drying agent is present in the composition in an amount of from about 1% to about 15% by weight of the composition, preferably from about 2% to about 10% by weight of the composition, and most preferably from about 5% to about 7% by weight of the composition. Preferably, the drying agent, in the amount employed, does not significantly detrimentally affect the clarity, stability, homogeneity, or other desirable physical characteristics of the wrinkle reducing composition.

Fragrance

In accordance with another aspect of an exemplary embodiment of the invention, a fragrance component is present in an amount of from about 0.01% to about 1.0% by weight of the composition. In one aspect of an exemplary embodiment of the invention, the fragrance component chosen serves not only to impart a pleasing aroma to the wrinkle reducing composition and to the fabric articles treated thereby, but also as both a malodor neutralizing agent and/or a malodor masking agent.

Fragrance components useful in connection with the present invention are available from any number of sources, for example, from International Flavors & Fragrances of New York, N.Y. and Robertet S. A., of Grasse, France. The fragrance component of the present invention may include any suitable fragrant compound now known or later developed, such as, for example, an alcohol, an essential oil, a phenol, and/or an ester. A variety of fragrance components are also available that employ any number of malodor neutralizing mechanisms and/or malodor masking agents, and any such fragrance components are suitable for use in connection with various exemplary embodiments of the present invention.

In an exemplary embodiment of the present invention, the fragrance component is selected from fragrances containing unsubstituted cyclohexyl alcohols and esters as disclosed in, for example, U.S. Pat. Nos. 4,719,105 and 4,622,221. Such fragrance components are available from International Flavors & Fragrances, and may exhibit any number of desirable odors. For example, desirable odors of various alkyl substituted cyclohexyl alkanols include, but are not limited to: cis/trans-4-tert butyl cyclohexyl methanol (green fresh steamy floral jasmine), cis/trans-1-(4-tert. butyl cyclohexyl)-1-ethanol (sharp floral musky), cis/trans-1-(4-ethyl cyclohexyl)-1-ethanol (floral woody fresh rose), cis/trans-1-(methyl cyclohexyl)-1-ethanol (sour citrus lime camphor), cis/trans-2-(4-methyl cyclohexenyl)-2-propanol (lilac), and 1-cis(4-isopropenylcyclohexyl)-methanol (flowery). As a further example, desirable odors of various substituted cyclohexyl alkyl esters include, but are not limited to: 4-isopropylcyclohexylmethyl acetate (fragrant, flowery), 1-(3,3 dimethylcyclohexyl)-1-ethanol acetate (sweet woody, floral), 1-(3-methylcyclohexyl)-1-ethyl acetate (fresh, clean, minty, woody), 2-(4′-methylcyclohexyl)-2-propanol acetate (mild herbaceous sweet spicy bergamot, lavender), and 2-cyclohexylethanol acetate (powerful, sweet, fruity).

In another exemplary embodiment of the present invention, the fragrance component is selected from selected from fragrances containing at least two aldehydes, as disclosed in, for example, U.S. Pat. No. 5,795,566. Such fragrance components are available from Robertet, S. A., and are generally characterized as having at least one aldehyde selected from acyclic aliphatic aldehydes, non-terpenic aliphatic aldehydes, non-terpenic alicyclic aldehydes, terpenic aldehydes, aliphatic aldehydes substituted by an aromatic group and bifunctional aldehydes, and at least one aldehyde selected from aldehydes possessing a non-aromatic unsaturation alpha carried by the carbon which is alpha to the aldehyde, aldehydes possessing an unsaturation alpha to the aldehyde function conjugated with an aromatic ring, and aldehydes in which the aldehyde group is on an aromatic ring. These fragrance components additionally comprise a fragrant agent imparting a desirable odor to the fragrance, such as, for example, alcohols, essential oils, phenols, and esters.

In an exemplary embodiment of the present invention, the fragrance component is present in the composition in an amount of from about 0.01% to about 1.0% by weight of the composition, preferably from about 0.02% to about 0.5% by weight of the composition, and most preferably from about 0.03% to about 0.05% by weight of the composition.

Although a solubilizing agent is typically required in compositions containing certain fragrance components, such as, for example, perfume oils, the present inventors have observed that wrinkle reducing compositions in accordance with various exemplary embodiments the present invention that comprise a combination of a quaternary silicone compound and a potassium salt of a silicone copolyol as the wetting agent do not require the addition of a separate fragrance solubilizing agent.

Optional Additives

In other exemplary embodiments of the present invention, the composition may include one or more other additives, such as preservatives, antifoaming agents, bacteriocides, fungicides, antistatic agents, miticides, insect repellants, UV absorbers/sunscreens, fabric color rejuvenators, colorants, and mixtures thereof. One or more of such additives may be present in any amount suitable to achieve a particular performance objective.

Preservative

Optionally, a solubilized preservative can be added to compositions formed in accordance with various embodiments of the present invention. As is known in the art, contamination of aqueous compositions by certain microorganisms with subsequent microbial growth can result in an unsightly and/or malodorous composition. Because microbial growth in aqueous compositions containing biodegradable components, such as biodegradable surfactants, is undesirable, it is preferable to include in such aqueous compositions an amount of a solubilized water-soluble, antimicrobial preservative that is effective for inhibiting and/or controlling microbial growth. Use of such a preservative in this way increases the storage stability of the preferably clear, aqueous wrinkle reducing composition.

It is preferable to utilize a preservative agent that is effective to inhibit and/or control both bacteria and fungi. When present, the water-soluble microbial preservative is included at an effective amount. The term “effective amount” as herein defined in connection with the preservative agent means a level sufficient to prevent spoilage or to prevent growth of microorganisms for a specific period of time, but not a level enough to affect the wrinkle reducing performance of the composition. Preferred levels of preservative, when present, are from about 0.01% to about 0.5% by weight of the composition, more preferably from about 0.02% to about 0.2% by weight of the composition, and most preferably from about 0.05% to about 0.1% by weight of the composition.

Suitable preservatives may include any organic preservative that will not adversely affect or damage fabric articles or fibrous surfaces in the amounts present in the wrinkle reducing compositions of the present invention. Preferred water-soluble preservatives include, for example, halogenated compounds, hydantoin compounds, organic sulfur compounds, low molecular weight aldehydes, cyclic organic nitrogen compounds, quaternary compounds, dehydroacetic acid, phenyl and phenoxy compounds, and mixtures thereof. In accordance with an aspect of an exemplary embodiment of the present invention, an effective amount of Dantogard® preservative, available from Lonza Group of Switzerland, is utilized in a wrinkle reducing composition.

pH Adjusting Agents

It is preferable that the pH of the composition be adjusted to less than about 8, more preferably less than about 7, and most preferably from about 4 to about 6. Various pH-adjusting agents are known in the art and can be used to bring the pH of the composition of the instant invention to within the preferred range. The present inventors have observed that adjusting the pH of the composition to these levels can result in improved stability and clarity of the composition. In one aspect of an exemplary embodiment of the invention, the pH-adjusting agent is selected from the group consisting of citric acid, lactic acid, phosphoric acid, and mixtures thereof. In one aspect of a preferred embodiment of the invention, citric acid is present in an amount effective to adjust the pH of the composition to within the preferred pH range, generally in an amount from about 0.1% to about 1.0% by weight of the composition.

Coloring Agents

Optionally, compositions formulated in accordance with the various aspects of the present invention may also include coloring agents or dyes to increase the aesthetic appeal and consumer performance impression of the compositions. When present, such coloring agents and/or dyes are preferably used at very low levels to avoid staining or marking fabric articles on which the compositions may be used. A wide variety of coloring agents and dyes suitable for use in accordance with the present invention are well known to those skilled in the art. In accordance with a preferred aspect of an exemplary embodiment of the invention, water-soluble dyes, such as, for example, food dyes, may be used in small amounts. For example, about 0.000025% by weight of FD&C Red No. 4 may be used for a light pink tint, a mixture of about 0.000025% by weight of FD&C Red No. 4 and about 0.000050% by weight of FD&C Yellow No. 6 may be used to achieve a composition having a light orange tint, or a mixture of about 0.000010% by weight of FD&C Blue No. 1 and about 0.000030% by weights of FD&C Yellow No. 6 may be used to achieve a composition having a light green tint. When used in connection with wrinkle reducing compositions packaged in transparent bottles, these exemplary tints may be used to distinguish variously fragranced compositions on a retail store shelf and to increase consumer purchase appeal. For example, compositions formulated in accordance with the present invention and tinted in accordance with the above described exemplary aspect can be packaged in natural high density polyethylene (HDPE), clear polyethylene terephthalate (PET) or polyvinylchloride (PVC) plastic bottles, allowing the tinted compositions to be visible through the packaging.

In an exemplary embodiment of the invention, optional additives, alone or combined, are not present in an amount that is greater than about 4% by weight of the composition, however. More preferably, these additives, alone or combined, are present in an amount that is less than about 2% by weight of the composition, and even more preferably, less than about 1% by weight of the composition. However, any effective amount of optional additives, alone or combined, may be utilized in accordance with the present invention insofar as such additives do not substantially detrimentally affect the clarity, stability, and/or performance of the wrinkle reducing composition.

Dispensing Device

In accordance with one aspect of an exemplary embodiment of the invention, a wrinkle reducing composition formulated in accordance with any of the above-described embodiments may be used, for example, as a fabric refresher and de-wrinkling composition.

In accordance with an exemplary embodiment of the present invention, an article of manufacture comprises a spray dispenser and a wrinkle reducing composition. The wrinkle reducing composition in accordance with one of the various embodiments described in greater detail hereinabove is placed into a spray dispenser suitable for distributing the composition onto the surface of a fabric article. The spray dispenser may comprise any manually operated or automated means of producing a mist of liquid droplets, such as, for example, trigger-type, pump-type, non-aerosol self-pressurized, and aerosol-type spray means.

Preferably, a wrinkle reducing composition formulated in accordance with any of the above-described embodiments is dispensed such that the droplet size, dispersion angle, dispersion pattern, dispersion volume and/or dispersion velocity enable effective application of the composition onto the surface of a fabric article with a minimum number of activations of the spray dispenser. Similarly, when used as a fabric freshener and de-wrinkling composition, a wrinkle reducing composition formulated in accordance with any of the above-described embodiments is dispensed such that the droplet size, dispersion angle, dispersion pattern, dispersion volume and/or dispersion velocity enable effective coverage of the surface of the article to be treated with a minimum number of activations of the spray dispenser.

In accordance with one aspect of an exemplary embodiment of the invention, it is preferred that the droplets have an average particle size of from about 50 to about 250 μm. More preferably, the droplets will have an average particle size of from about 60 to about 150 am, and most preferably, the droplets will have an average particle size of from about 80 to about 120 μm.

In accordance with one exemplary embodiment of the present invention, a TS800® trigger sprayer manufactured by Saint-Gobain Calmar Inc. of Lee's Summit, Mo., is utilized. In accordance with another exemplary embodiment of the present invention, a Guala® trigger sprayer manufactured by Berry Plastics Corp., located in Evansville, Ind., is used. Preferably, the trigger sprayer chosen will exhibit uniform spray characteristics, suitable spray volume, and suitable spray pattern size and shape that enable efficient and effective application of the wrinkle reducing composition to the fabric. Any suitable bottle or container can be used with the trigger sprayer. In a preferred embodiment of the present invention, compositions formulated in accordance with the present invention and/or tinted in accordance with the above described exemplary aspects can be packaged in natural high density polyethylene (HDPE), clear polyethylene terephthalate (PET) or polyvinylchloride (PVC) plastic bottles, allowing the tinted or untinted compositions to be visible through the packaging.

Method of Use

Wrinkle reducing compositions in accordance with various exemplary embodiments of the present invention may be used to effectively reduce wrinkles in fabric articles in a number of ways. For example, an effective amount of the wrinkle reducing composition may be applied to a fabric article via a dispensing device, such as a spray dispenser as described above. As used herein, an “effective amount” of a wrinkle reducing composition is that amount of composition required to achieve noticeable reduction of wrinkles in a fabric article, either alone or combined with mechanical action, such as, for example, stretching, smoothing, hanging, ironing, tumble drying, or the like. Typically, an “effective amount” of a wrinkle reducing composition will be less than an amount required to fully saturate a fabric article.

Once an effective amount of the wrinkle reducing composition is applied to the fabric article, the fabric article may optionally, but preferably, be stretched, smoothed, or otherwise manually manipulated to assist in the removal of wrinkles from the fabric article. Stretching, smoothing, and/or other manual or mechanical manipulations may be performed when the fabric article is hanging or on a flat surface to facilitate wrinkle removal. After application of the composition and optional manual or mechanical manipulation, the fabric article is preferably hung until fully dried.

In accordance with another embodiment of the invention, the wrinkle reducing composition may be used as an ironing aid. For example, after an effective amount of the wrinkle reducing composition is applied to the fabric article, the fabric article may be immediately ironed using an iron of suitable temperature for the untreated fabric. Wrinkle reducing compositions in accordance with various embodiments of the invention are particularly useful as ironing aids for dark-colored fabric articles, since the compositions preferably do not leave a visible and/or flaky residue on the fabric articles in the way that, for example, spray starch and other ironing aids do. In accordance with one embodiment of the invention, a fabric article may be treated with the wrinkle reducing composition and allowed to dry, and then ironed.

In accordance with yet another embodiment of the invention, the wrinkle reducing composition may be applied to a fabric article that is then tumbled in a dryer at a temperature suitable for the fabric. When a heated dryer is used to tumble a fabric article treated with the wrinkle reducing composition, it may be preferable to apply slightly more of the wrinkle reducing composition to the fabric article than what would constitute an effective amount in accordance with embodiments of the invention utilizing other methods of manipulation.

Various principles of the invention have been described in illustrative embodiments. However, many combinations and modifications of the above-described structures, arrangements, proportions, elements, materials and components, used in the practice of the invention, in addition to those not specifically described, may be varied and particularly adapted to specific environments and operating requirements without departing from those principles. Stated another way, the above description presents exemplary modes contemplated in carrying out the invention and the techniques described are susceptible to modifications and alternate constructions from the embodiments shown above. Other variations and modifications of the present invention will be apparent to those of ordinary skill in the art, and it is the intent of the appended claims that such variations and modifications be covered.

Consequently, it is not the intention to limit the invention to the particular embodiments disclosed. On the contrary, the invention is intended to cover all modifications and alternate constructions falling within the scope of the invention, as expressed in the following claims when read in light of the description. No element described in this specification is necessary for the practice of the invention unless expressly described herein as “essential” or “required.”

1. A composition for reducing wrinkles in fabric articles comprising:
from about 0.25% to about 16% by weight of a silicone compound;
from about 0.05% to about 3.5% by weight of a wetting agent;
from about 1% to about 15% by weight of a drying agent;
at least about 65% by weight of a liquid carrier, and
from about 0.01% to about 1% by weight of a fragrance.

2. The composition of claim 1, wherein said silicone compound comprises a silicone quaternary compound.

3. The composition of claim 1, wherein said silicone compound is present in an amount of from about 0.5% to about 5% by weight of the composition.

4. The composition of claim 1, wherein said wetting agent comprises a potassium salt of a silicone copolyol.

5. The composition of claim 1, wherein said wetting agent is present in an amount of from about 0.2% to about 1% by weight of the composition.

6. The composition of claim 1, wherein the weight ratio of said wetting agent to said silicone compound is about 1:5.

7. The composition of claim 1, wherein said drying agent comprises at least one of a low molecular weight monohydric alcohol, a polyol, a polyol derivative, or a glycol ether.

8. The composition of claim 1, wherein said drying agent comprises ethanol.

9. The composition of claim 1, wherein said drying agent is present in an amount of from about 2% to about 10% by weight of the composition.

10. The composition of claim 1, wherein said liquid carrier comprises water.

11. The composition of claim 1, wherein said liquid carrier comprises from about 88% to about 93% by weight of the composition.

12. The composition of claim 1, further comprising from about 0.01% to about 0.5% by weight of a preservative.

13. The composition of claim 1, further comprising at least one of an antifoaming agent, a bacteriocide, a fungicide, an antistatic agent, a miticide, an insect repellant, a UV absorber, a sunscreen, a fabric color rejuvenator, or a colorant.

14. An article of manufacture comprising:
a composition for reducing wrinkles in fabric articles, said composition comprising
from about 0.25% to about 16% by weight of a silicone compound;
from about 0.05% to about 3.5% by weight of a wetting agent;
from about 1% to about 15% by weight of a drying agent;
at least about 65% by weight of a liquid carrier, and
from about 0.01% to about 1% by weight of a fragrance; and
a dispensing device.

15. The article of manufacture of claim 14, wherein said dispensing device comprises a spray dispenser.

16. The article of manufacture of claim 14, wherein said spray dispenser is adapted to distribute said wrinkle reducing composition in the form of droplets having an average particle size of from about 50 to about 250 μm.

17. A method of reducing wrinkles in a fabric article, comprising the steps of:
applying to a fabric article a composition comprising from about 0.25% to about 16% by weight of a silicone compound, from about 0.05% to about 3.5% by weight of a wetting agent; from about 1% to about 15% by weight of a drying agent, at least about 65% by weight of a liquid carrier, and from about 0.01% to about 1% by weight of a fragrance;
manipulating said fabric article; and
allowing said fabric article to dry.

18. The method of claim 17, wherein said step of applying said composition to said fabric article comprises spraying said composition onto said fabric article using a spray dispenser.

19. The method of claim 17, wherein said step of manipulating said fabric article comprises at least one of stretching, smoothing, hanging, ironing, or tumbling.

20. The method of claim 17, wherein said step of allowing said fabric article to dry is performed prior to said step of manipulating said fabric article, and wherein said step of manipulating said fabric article comprises ironing said fabric article with a heated iron.
